(19) United States
(12) Patent Application Publication
(10) Pub. No.: US 2022/0222127 A1
(43) Pub. Date: Jul. 14, 2022

(54) METHOD, APPARATUS AND SYSTEM FOR HIGH PERFORMANCE PERIPHERAL COMPONENT INTERCONNECT DEVICE RESOURCE SHARING IN CLOUD ENVIRONMENTS

(71) Applicant: Telefonaktiebolaget LM Ericsson (publ), Stockholm (SE)

(72) Inventors: Xu LIU, Mont-Royal (CA); Wubin LI, Kirkland (CA); Yves LEMIEUX, Kirkland (CA); Abdelouahed GHERBI, Laval (CA); Hibat Allah OUNIFI, Montreal (CA)

(21) Appl. No.: 17/613,203

(22) PCT Filed: Jun. 6, 2019
(86) PCT No.: PCT/IB2019/054737

§ 371 Date: Nov. 22, 2021

(51) Int. Cl. G06F 9/50; G06F 9/4401; G06N 20/00

(52) U.S. Cl. CPC G06F 9/5077; G06F 9/5072; G06N 20/00; G06F 9/4411; G06F 9/5044

(57) ABSTRACT

Apparatuses and methods are disclosed for virtualizing a peripheral component interconnect, PCI, device. In one embodiment, a method includes transmitting a request for use of the PCI device; and receiving an indication of an attachment of a VM server to the VM client, the VM server being associated with the PCI device. In one embodiment, a method includes receiving a request to perform at least one computing process using the PCI device; and transmitting information resulting from performance of the at least one computing process using the PCI device. In another embodiment, a method includes receiving a request to use the PCI device; selecting a VM server out of a plurality of VM servers; and transmitting an indication of an attachment of the selected VM server to a VM client, the VM server being associated with the PCI device.

### TECHNICAL FIELD

Wireless communication and in particular, a method, apparatus and system for high performance peripheral component interconnect (PCI) device resource sharing in cloud environments.

### BACKGROUND

When running computation-intensive workloads, traditional processors such as central processing units (CPUs) in general cannot meet the requirements in terms of energy consumption and executing time. Thus, data centers may add additional hardware devices, such as graphics processing units (GPUs), to improve computing performance. However, without GPU virtualization, GPU resources may not be used and shared efficiently among different servers.

As a result, different GPU virtualization techniques have been created and used. Generally, there are three main methodologies to implement GPU virtualization, described as follows and as depicted in FIG. 1.

API Forwarding

As depicted in FIG. 1, with application programming interface (API) forwarding, a Frontend is in the virtual machines (VMs) and a Backend is in the hypervisor. The VMs use APIs to control the Backend and the Backend uses the APIs to control the physical GPU. The graphics driver is also installed in the hypervisor. With API forwarding, one GPU can be shared amongst many VMs.

Direct Pass-Through

With direct pass-through, a graphics driver is installed on a single VM and a single physical GPU attaches to the single VM graphics driver. Direct pass-through provides improved performance (e.g., as compared to API forwarding) and can allow for taking advantage of the full features of the GPU. However, with direct pass-through, one physical GPU cannot be shared amongst many VMs.

Full GPU Virtualization

As depicted in FIG. 1, in “full GPU virtualization” a physical GPU is split into multiple virtual GPUs, and each virtual GPU is assigned to a VM. The VM can have access to the full features of GPU but still shares the physical GPU with other VMs. Thus, full GPU virtualization has general performance and some sharing capabilities. Some problems with these existing solutions are summarized in the table below, Table.

TABLE 1
Summary of GPU virtualization methodologies.

| Existing Solutions | Problems |
|---|---|
| API Forwarding | Poor performance and does not expose full |
| | features of GPU. Too much coupling (the |
| | backend can become the single point of |
| | failure.) |
| Direct Pass-Through | One GPU can only be used by one VM, no |
| | sharing ability. |
| Full GPU Virtualization | Poor flexibility, poor scalability and poor |
| | redundancy, one GPU can only support a |
| | limited number of VMs, and if a GPU fails/ |
| | error, all VMs that depend on the GPU will |
| | lose GPU support. |

Additionally, the above methodologies have a common issue. When the VMs and GPUs are not co-located in the same ‘bare metal’, i.e., chassis, the VMs transfer huge amounts of data back and forth (e.g., to and from the GPU) frequently over the network.

### SUMMARY

Some embodiments advantageously provide a method, apparatus and system for high performance PCI device(s) resource sharing in cloud environments.

According to a first aspect of the present disclosure, a method for a virtual machine, VM, client for using a virtualized peripheral component interconnect, PCI, device is provided. The method includes transmitting a request for use of the PCI device. The method includes, as a result of the request, receiving an indication of an attachment of a VM server to the VM client, the VM server being associated with the PCI device.

In some embodiments of the first aspect, the PCI device includes a graphics processing unit, GPU. In some embodiments of the first aspect, the VM server is allowed a direct pass-through to the PCI device. In some embodiments of the first aspect, the VM server is allowed exclusive access to the PCI device. In some embodiments of the first aspect, the VM server bypasses a hypervisor associated with a virtual environment, the virtual environment including the VM client and the VM server. In some embodiments of the first aspect, the VM server having device drivers for the PCI device. In some embodiments of the first aspect, the method includes transmitting a request to the VM server to perform at least one computing process using the PCI device; and receiving information resulting from performance of the at least one computing process using the PCI device. In some embodiments of the first aspect, the method further includes using an application programming interface, API, associated with the VM server to run at least one computing process on the VM server using the PCI device. In some embodiments of the first aspect, the method further includes transmitting an indication of at least one requirement associated with the PCI device, the VM server being selected based at least in part on the at least one requirement. In some embodiments of the first aspect, the method further includes allocating the at least one computing process to the VM server; and as a result of receiving information resulting from performance of the at least one computing process using the PCI device, collecting and synchronizing the received information.

According to a second aspect of the present disclosure, a method for a server selector for virtualizing a physical peripheral component interconnect, PCI, device, is provided. The method includes receiving a request to use the PCI device. The method includes, as a result of the request, selecting a virtual machine, VM, server out of a plurality of VM servers. The method includes transmitting an indication of an attachment of the selected VM server to a VM client, the VM server being associated with the PCI device.

In some embodiments of the second aspect, the method includes receiving an indication of at least one requirement associated with the PCI device, the VM server being selected based at least in part on the at least one requirement. In some embodiments of the second aspect, the method includes attaching the selected VM server to the VM client. In some embodiments of the second aspect, the method includes obtaining application programming interface, API, information from the VM server. In some embodiments of the second aspect, the method includes obtaining a status of the VM server. In some embodiments of the second aspect, the method includes updating a status table with the obtained status of the VM server; and performing an operation based on the obtained status. In some embodiments of the second aspect, each of the plurality of VM servers is allowed exclusive access to a single PCI device. In some embodiments of the second aspect, the method includes using machine learning to at least one of select the VM server out of the plurality of VM servers and manage the plurality of VM servers.

According to a third aspect of the present disclosure, a method for a virtual machine, VM, server for virtualizing a peripheral component interconnect, PCI, device is provided. The method includes receiving, from a VM client, a request to perform at least one computing process using the PCI device; and transmitting information resulting from performance of the at least one computing process using the PCI device.

In some embodiments of the third aspect, the method includes performing the at least one computing process by running, at the VM server, the at least one computing process using the PCI device. In some embodiments of the third aspect, the receiving the request further includes receiving the request to perform the at least one computing process via an application programming interface, API, associated with the VM server. In some embodiments of the third aspect, the method further includes obtaining data on which to perform the at least one computing process; and performing the at least one computing process by running, at the VM server, the at least one computing process on the data using the PCI device. In some embodiments of the third aspect, the method further includes providing, to a server selector, at least one of application programming interface, API, information associated with the VM server and a status of the VM server to the server selector. In some embodiments of the third aspect, the PCI device is a graphics processing unit, GPU. In some embodiments of the third aspect, the method further includes performing the at least one computing process via at least one of a direct pass-through to the PCI device; exclusive access to the PCI device; bypassing a hypervisor associated with a virtual environment, the virtual environment including the VM client and the VM server; and device drivers for the PCI device.

According to a fourth aspect of the present disclosure, a device for a virtual machine, VM, client for using a virtualized peripheral component interconnect, PCI, device is provided. The device includes processing circuitry and memory, the memory including instructions and the processing circuitry configured to execute the instructions to cause the device to transmit a request for use of the PCI device; and as a result of the request, receive an indication of an attachment of a VM server to the VM client, the VM server being associated with the PCI device.

In some embodiments of the fourth aspect, the PCI device includes a graphics processing unit, GPU. In some embodiments of the fourth aspect, at least one of: the VM server is allowed a direct pass-through to the PCI device; the VM server is allowed exclusive access to the PCI device; the VM server bypasses a hypervisor associated with a virtual environment, the virtual environment including the VM client and the VM server; and the VM server having device drivers for the PCI device. In some embodiments of the fourth aspect, the processing circuitry is further configured to execute the instructions to cause the device to transmit a request to the VM server to perform at least one computing process using the PCI device; and receive information resulting from performance of the at least one computing process using the PCI device. In some embodiments of the fourth aspect, the processing circuitry is further configured to execute the instructions to cause the device to use an application programming interface, API, associated with the VM server to run at least one computing process on the VM server using the PCI device. In some embodiments of the fourth aspect, the processing circuitry is further configured to execute the instructions to cause the device to transmit an indication of at least one requirement associated with the PCI device, the VM server being selected based at least in part on the at least one requirement. In some embodiments of the fourth aspect, the processing circuitry is further configured to execute the instructions to cause the device to allocate the at least one computing process to the VM server; and as a result of receiving information resulting from performance of the at least one computing process using the PCI device, collect and synchronize the received information.

According to a fifth aspect of the present disclosure, a device for a server selector for virtualizing a peripheral component interconnect, PCI, device, is provided. The device comprising processing circuitry and memory, the memory comprising instructions and the processing circuitry configured to execute the instructions to cause the device to receive a request to use the PCI device; as a result of the request, select a virtual machine, VM, server out of a plurality of VM servers; and transmit an indication of an attachment of the selected VM server to a VM client, the VM server being associated with the PCI device.

In some embodiments of the fifth aspect, the processing circuitry is further configured to execute the instructions to cause the device to receive an indication of at least one requirement associated with the PCI device, the VM server being selected based at least in part on the at least one requirement. In some embodiments of the fifth aspect, the processing circuitry is further configured to execute the instructions to cause the device to attach the selected VM server to the VM client. In some embodiments of the fifth aspect, the processing circuitry is further configured to execute the instructions to cause the device to obtain application programming interface, API, information from the VM server. In some embodiments of the fifth aspect, the processing circuitry is further configured to execute the instructions to cause the device to obtain a status of the VM server; and at least one of: update a status table with the obtained status of the VM server; and perform an operation based on the obtained status. In some embodiments of the fifth aspect, each of the plurality of VM servers is allowed exclusive access to a single PCI device. In some embodiments of the fifth aspect, the processing circuitry is further configured to execute the instructions to cause the device to use machine learning to at least one of select the VM server out of the plurality of VM servers and manage the plurality of VM servers.

According to a sixth aspect of the present disclosure, a device for a virtual machine, VM, server for virtualizing a peripheral component interconnect, PCI, device, is provided. The device includes processing circuitry and memory, the memory including instructions and the processing circuitry configured to execute the instructions to cause the device to receive, from a VM client, a request to perform at least one computing process using the PCI device; and transmit information resulting from performance of the at least one computing process using the PCI device.

In some embodiments of the sixth aspect, the processing circuitry is further configured to execute the instructions to cause the device to perform the at least one computing process by running, at the VM server, the at least one computing process using the PCI device. In some embodiments of the sixth aspect, the processing circuitry is further configured to receive the request by being further configured to receive the request to perform the at least one computing process via an application programming interface, API, associated with the VM server. In some embodiments of the sixth aspect, the processing circuitry is further configured to execute the instructions to cause the device to obtain data on which to perform the at least one computing process; and perform the at least one computing process by running, at the VM server, the at least one computing process on the data using the PCI device. In some embodiments of the sixth aspect, the processing circuitry is further configured to execute the instructions to cause the device to provide, to a server selector, at least one of application programming interface, API, information associated with the VM server and a status of the VM server to the server selector. In some embodiments of the sixth aspect, the PCI device is a graphics processing unit, GPU. In some embodiments of the sixth aspect, the processing circuitry is further configured to execute the instructions to cause the device to perform the at least one computing process via at least one of: a direct pass-through to the PCI device; exclusive access to the PCI device; bypassing a hypervisor associated with a virtual environment, the virtual environment including the VM client and the VM server; and device drivers for the PCI device.

According to a seventh aspect of the present disclosure, a system for providing a virtualized peripheral component interconnect, PCI, device, is provided. The system includes a VM client device comprising processing circuitry and memory, the memory comprising instructions and the processing circuitry configured to execute the instructions to cause the VM client device to: transmit a request for use of the PCI device; and as a result of the request, receive an indication of an attachment of a VM server to the VM client, the VM server being associated with the PCI device. The system includes a server selector device comprising processing circuitry and memory, the memory comprising instructions and the processing circuitry configured to execute the instructions to cause the server selector device to receive the request to use the PCI device; as a result of the request, select the VM server out of a plurality of VM servers; and transmit the indication of the attachment of the selected VM server to the VM client. The system includes a VM server device comprising processing circuitry and memory, the memory comprising instructions and the processing circuitry configured to execute the instructions to cause the VM server device to: receive, from the VM client, a request to perform at least one computing process using the PCI device; and transmit information resulting from performance of the at least one computing process using the PCI device.

According to an eighth aspect, there is provided a non-transitory computer-readable storage medium containing program instructions to perform any of the methods disclosed herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram illustrating an overview of GPU virtualization methodologies;

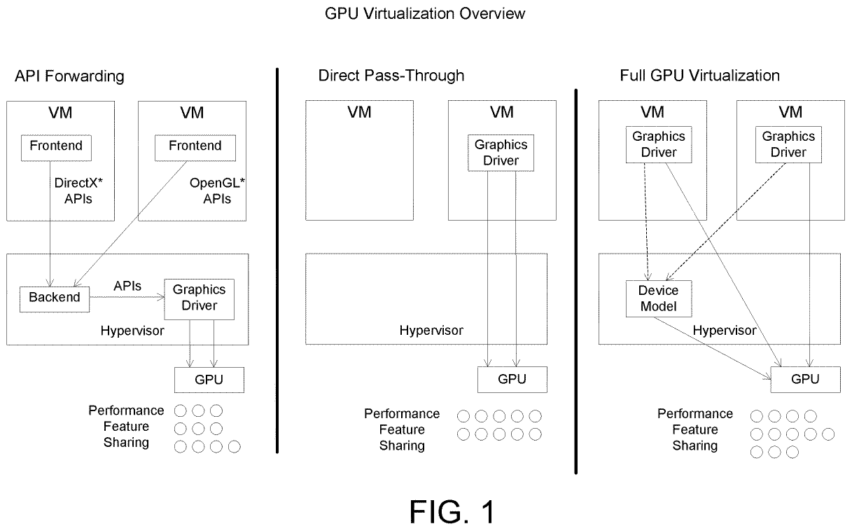

FIG. 2 is a schematic diagram of an exemplary cloud architecture illustrating a communication system according to the principles in the present disclosure;

FIG. 3 is a block diagram of a VM client device, a server selector device and a VM server device in communication with one another according to some embodiments of the present disclosure;

FIG. 4 is a flowchart of an exemplary process in a VM client for PCI VM client according to some embodiments of the present disclosure;

FIG. 5 is a flowchart of an exemplary process in a server selector for PCI server selector according to some embodiments of the present disclosure;

FIG. 6 is a flowchart of an exemplary process in a VM server for PCI VM server according to some embodiments of the present disclosure;

FIG. 7 is a flow diagram for GPU virtualization according to some embodiments of the present disclosure; and

FIG. 8 is a flow diagram for a server selector checking and/or updating status of a PCI VM server according to some embodiments of the present disclosure.

### DETAILED DESCRIPTION

Some embodiments of the present disclosure improve the energy consumption and performance of the data center as compared with known solutions by increasing the sharing and using efficiency of PCI computing resources (e.g., GPU, FPGA) as compared with those known solutions.

Some embodiments of the present disclosure may include one or more of the following:

1. For each physical PCI hardware resource, a server VM is created and/or assigned to the PCI hardware resource. The server VM is configured for pass-through to the physical PCI hardware resource.

2. One (or two (for redundancy)) virtual server selectors are created. The selector dynamically and automatically allocates and attaches PCI VM servers to the VM clients according to the customer's requirements. The server selector also continuously checks every VM server's health and running status. When any abnormal situation is detected, the selector can handle the situation by, e.g., restarting the VM server and attaching backup VM servers to the VM client. By keeping track of the historical allocation and using machine learning, the server selector can become more intelligent over time. The VM servers are configured for workload execution, which includes data preparation, data aggregation, etc.

3. The VM clients are configured to allocate the customers' workload to the respective VM servers, and for collecting and synchronizing the results from the VM servers.

Advantageously, the arrangements provided by the present disclosure allow for the improved performance of the PCI devices to be preserved by using pass-through, because the PCI VM server with the physical PCI device may have almost the same performance as the bare-metal server with PCI device.

Additionally, or alternatively, the PCI accelerating VM servers are independent and therefore failure on one server VM will not affect other VM clients and VM servers. Additionally, or alternatively, machine learning can be used to improve the schedule efficiency of the PCI accelerating resources.

Thus, some embodiments of the present disclosure provide for high-density computing and data preparing workloads/processes/jobs are put on the VM servers (e.g., instead of VM clients). This can avoid frequently transferring data between VM clients and VM servers.

Before describing in detail exemplary embodiments, it is noted that the embodiments reside primarily in combinations of apparatus components and processing steps related to high performance PCI device(s) resource sharing in cloud environments. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “device” used herein can be any kind of device, such as, for example, a computing device, a processor (e.g., single or multi-core processor), a controller, a microcontroller, or other processor or processing/controlling circuit, a machine, a mobile wireless device, a user equipment, a central processing unit (CPU), a server, a client device, a compute resource, a personal computer (PC), a computer tablet, etc.

In some embodiments, the term “PCI device” as used herein is intended broadly to cover a device using any type of PCI, such as, for example, PCI, PCI-e, PCI-X. Non-limiting examples of a PCI device include a graphics processing unit (GPU) and a field-programmable-gate array (FPGA).

In some embodiments, the terms “workload,” “computing process,” and/or “accelerating job” are used interchangeably and are intended broadly to encompass workload threads, processes, sets of instructions and/or any work, task, instruction set or job to be performed by a computing and/or processing device according to the arrangements disclosed herein, such as the PCI VM server and/or the PCI device.

As used herein, the terms “VM client” and “PCI VM client” are used interchangeably. As used herein, the terms “VM server” and “PCI VM server” are used interchangeably. As used herein, the terms “server selector” and “PCI server selector” are used interchangeably.

Note that functions described herein as being performed by a VM server device, server selector device or VM server device may be distributed over a plurality of VM server devices, server selector devices or VM server devices. In other words, it is contemplated that the functions of the VM server device, server selector device and VM server device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

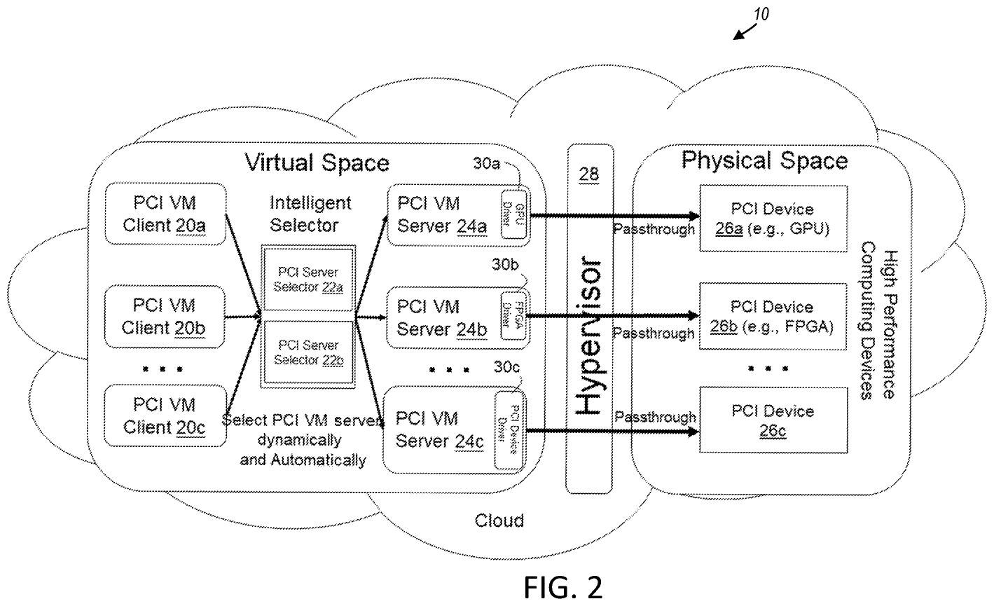

Referring again to the drawing figures, in which like elements are referred to by like reference numerals, there is shown in FIG. 2 a schematic diagram of a communication system 10, according to an embodiment, constructed in accordance with the principles of the present disclosure. The communication system 10 in FIG. 2 is a non-limiting example and other embodiments of the present disclosure may be implemented by one or more other systems and/or networks. The system 10 includes a plurality of VM PCI clients 20a, 20b and 20c (collectively referred to as “VM PCI clients 20”), a plurality of PCI server selectors 22a and 22b (collectively referred to as “PCI server selector 22”) and a plurality of VM PCI servers 24a, 24b and 24c (collectively referred to as “VM PCI server 24”) in e.g., a virtual space of a cloud environment. The system 10 further includes a plurality of physical PCI accelerating devices, PCI device 26a (e.g., GPU), PCI device 26b (e.g., FPGA) and PCI device 26c (e.g., any other type of PCI device) (collectively referred to as “PCI device 26”) and a hypervisor 28. The hypervisor 28 manages instances of VMs associated with the cloud environment and may also be known as a virtualization manager or virtual machine manager (VMM). The hypervisor 28 may control interactions between the VMs (e.g., VM PCI clients 20, VM PCI server 24) and/or the PCI server selectors 22 and the various physical hardware devices, such as the PCI devices 26 and other physical resources (e.g., compute, network, storage resources).

As would be recognized by one of ordinary skill in the art, a VM may be considered a virtual instance of a physical computer system and may include an instance of an operating system (OS). Each of the VM PCI servers 24 includes a device driver 30 (30a, 30b or 30c) for the respective physical PCI device 26 and is shown as having a direct pass-through to the respective physical PCI device 26 according to the arrangements provided in the present disclosure. Advantageously, such arrangements may preserve performance of the PCI devices 26 by using pass-through, as the VM PCI server 24 with PCI device 26 may, in some embodiments, have almost the same performance as the ‘bare-metal’ server with PCI device. In addition, high-density computing and data preparing jobs can be put on the VM PCI servers 24 to e.g., avoid frequently transferring data between the VM PCI client 20 and the corresponding VM PCI server 24.

Note that although only three VM PCI clients 20, two PCI selector servers 22 and three VM PCI servers 24 are shown for convenience, the communication system 10 may include many more VM PCI clients 20, PCI selector servers 22 and VM PCI servers 24.

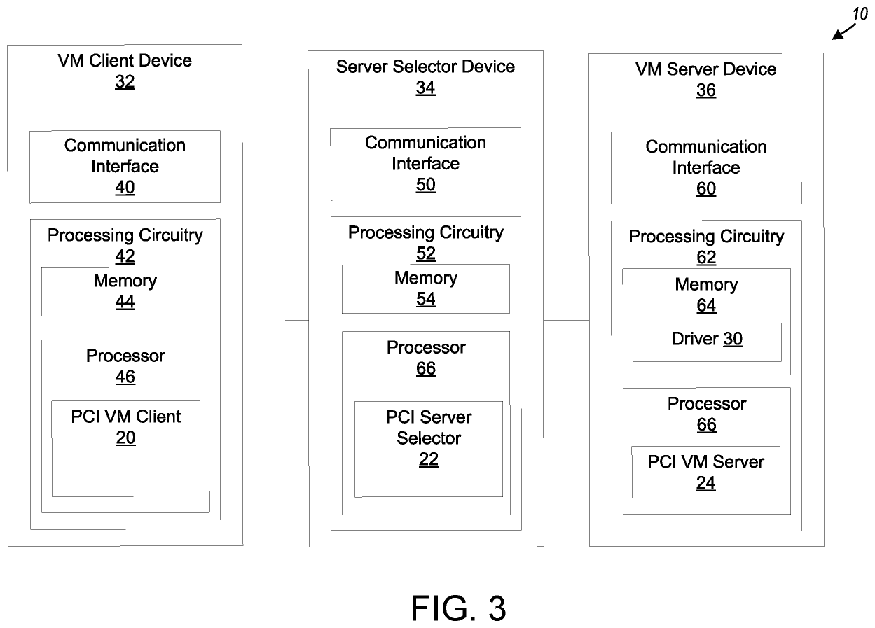

Referring now to FIG. 3, another example system 10 in accordance with the present disclosure is shown. The system 10 includes a VM client device 32, a server selector device 34 and a VM server device 36. The VM client device 32 includes a VM PCI client 20 which is configured to transmit a request for use of the PCI device 26; and as a result of the request, receive an indication of an attachment of the VM server 24 to the VM client 20, the VM server 24 being associated with the PCI device 26.

A server selector device 34 includes a PCI VM server selector 22 which is configured to receive a request to use the PCI device 26; as a result of the request, select a virtual machine, VM, server 24 out of a plurality of VM servers 24; and transmit an indication of an attachment of the selected VM server 24 to a VM client 20, the VM server 24 being associated with the PCI device 26.

A VM server device 36 includes the device driver 30 and a VM PCI server 24 which is configured to receive, from a VM client 20, a request to perform at least one computing process using the PCI device 26; and transmit information resulting from performance of the at least one computing process using the PCI device 26.

Note that although only a single VM client device 32, a single server selector device 34 and a single VM server device 36 are shown for convenience, the communication system 10 may include many more VM client devices 32, a server selector devices 34 and VM server devices 36.

Example implementations, in accordance with an embodiment, of the VM client device 32, the server selector device 34 and the VM server device 36 discussed in the preceding paragraphs will now be described with reference to another example system 10 depicted in FIG. 3. It should be noted that although the example embodiment in FIG. 3 shows the VM client device 32, the server selector device 34 and the VM server device 36 as separate devices, each having its own components (e.g., communication interface, processing circuitry, memory, processor, etc.), since some embodiments are implemented in a cloud computing environment, the functionality described herein with respect to each device 32, 34 and 36 may be implemented by physical devices and/or resources distributed within the cloud computing environment. Thus, for example, use of the term “VM server device” may be used herein to indicate a VM configured as a server providing services according to the techniques described herein and which may be operating using one or more physical resources (e.g., compute, network, storage, etc.) in the cloud. Likewise, use of the term “VM client device” may be used herein to indicate a VM configured as a client submitting requests according to the techniques described herein and which may be operating using one or more physical resources (e.g., compute, network, storage, etc.) in the cloud. Similarly, the “server selector device” may be operating using one or more physical resources (e.g., compute, network, storage, etc.) in the cloud.

The VM client device 32 includes (and/or uses) a communication interface 40, processing circuitry 42, and memory 44. The communication interface 40 may be configured to communicate with the server selector device 34, VM server device 36 and/or other elements in the system 10 to facilitate use of one or more PCI devices 26 for e.g., accelerating job and/or high-density computing job (e.g., machine learning, medical imaging, etc.). In some embodiments, the communication interface 40 may be formed as or may include, for example, one or more radio frequency (RF) transmitters, one or more RF receivers, and/or one or more RF transceivers, and/or may be considered a radio interface. In some embodiments, the communication interface 40 may include a wired interface, such as one or more network interface cards.

The processing circuitry 42 may include one or more processors 46 and memory, such as, the memory 44. In particular, in addition to a traditional processor and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 46 may be configured to access (e.g., write to and/or read from) the memory 44, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

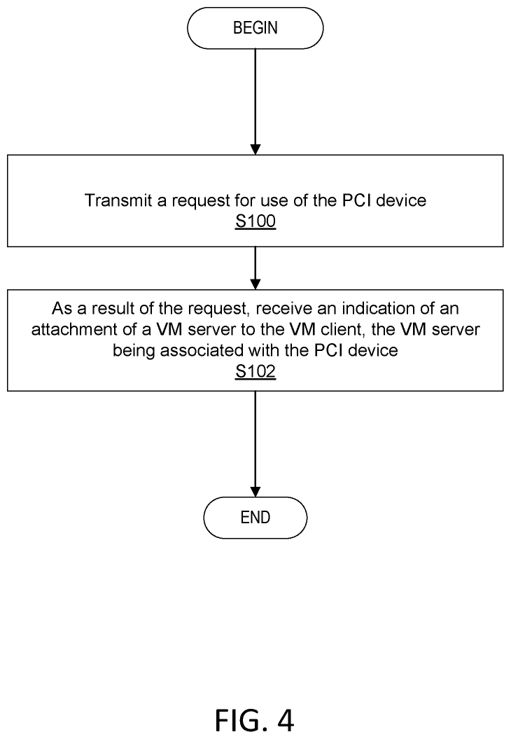

Thus, the VM client device 32 may further include software stored internally in, for example, memory 44, or stored in external memory (e.g., storage resource in the cloud) accessible by the VM client device 32 via an external connection. The software may be executable by the processing circuitry 42. The processing circuitry 42 may be configured to control any of the methods and/or processes described herein and/or to cause such methods, and/or processes to be performed, e.g., by the VM client device 32. The memory 44 is configured to store data, programmatic software code and/or other information described herein. In some embodiments, the software may include instructions stored in memory 44 that, when executed by the processor 46 and/or PCI VM client 20, causes the processing circuitry 42 and/or configures the VM client device 32 to perform the processes described herein with respect to the VM client device 32 (e.g., processes described with reference to FIG. 4 and/or any of the other flowcharts).

The server selector device 34 includes (and/or uses) a communication interface 50, processing circuitry 52, and memory 54. The communication interface 50 may be configured to communicate with the VM client device 32, the VM server device 36 and/or other elements in the system 10 to facilitate use of one or more PCI devices 26 for e.g., accelerating job and/or high-density computing job (e.g., machine learning, medical imaging, etc.). In some embodiments, the communication interface 50 may be formed as or may include, for example, one or more radio frequency (RF) transmitters, one or more RF receivers, and/or one or more RF transceivers, and/or may be considered a radio interface. In some embodiments, the communication interface 50 may include a wired interface, such as one or more network interface cards.

The processing circuitry 52 may include one or more processors 56 and memory, such as, the memory 54. In particular, in addition to a traditional processor and memory, the processing circuitry 52 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 56 may be configured to access (e.g., write to and/or read from) the memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

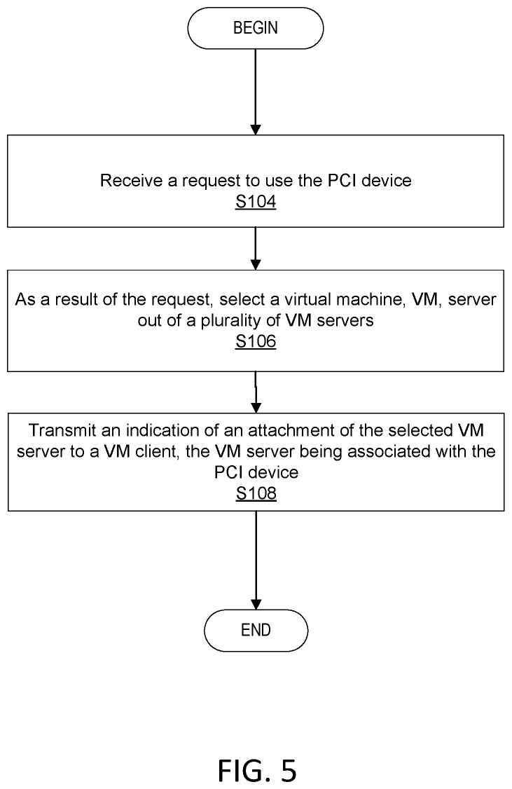

Thus, the server selector device 34 may further include software stored internally in, for example, memory 54, or stored in external memory (e.g., storage resource in the cloud) accessible by the server selector device 34 via an external connection. The software may be executable by the processing circuitry 52. The processing circuitry 52 may be configured to control any of the methods and/or processes described herein and/or to cause such methods, and/or processes to be performed, e.g., by the server selector device 34. The memory 54 is configured to store data, programmatic software code and/or other information described herein. In some embodiments, the software may include instructions stored in memory 54 that, when executed by the processor 56 and/or PCI server selector 22, causes the processing circuitry 52 and/or configures the server selector device 34 to perform the processes described herein with respect to the server selector device 34 (e.g., processes described with reference to FIG. 5 and/or any of the other flowcharts).

The VM server device 36 includes (and/or uses) a communication interface 60, processing circuitry 62, and memory 64. The communication interface 60 may be configured to communicate with the VM client device, the server selector device 34 and/or other elements in the system 10 to facilitate use of one or more PCI devices 26 for e.g., accelerating job and/or high-density computing job (e.g., machine learning, medical imaging, etc.). In some embodiments, the communication interface 60 may be formed as or may include, for example, one or more radio frequency (RF) transmitters, one or more RF receivers, and/or one or more RF transceivers, and/or may be considered a radio interface. In some embodiments, the communication interface 60 may include a wired interface, such as one or more network interface cards.

The processing circuitry 62 may include one or more processors 66 and memory, such as, the memory 64. In particular, in addition to a traditional processor and memory, the processing circuitry 62 may comprise integrated circuitry for processing and/or control, e.g., one or more processors and/or processor cores and/or

FPGAs (Field Programmable Gate Array) and/or ASICs (Application Specific Integrated Circuitry) adapted to execute instructions. The processor 66 may be configured to access (e.g., write to and/or read from) the memory 64, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

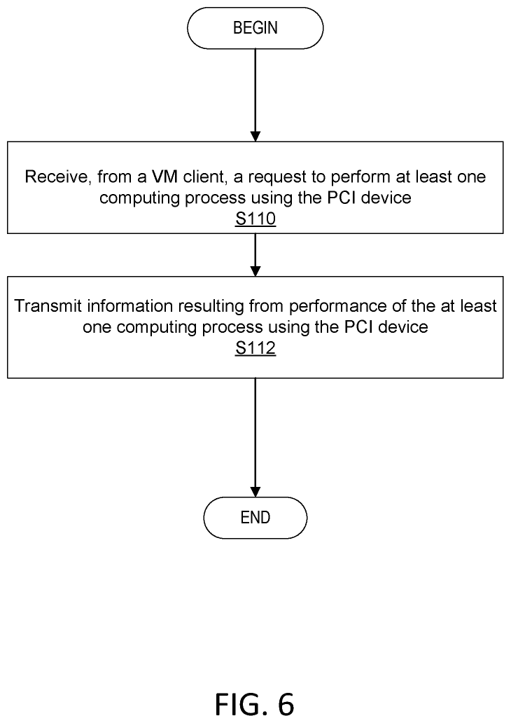

Thus, the VM server device 36 may further include software stored internally in, for example, memory 64, or stored in external memory (e.g., storage resource in the cloud) accessible by the VM server device 36 via an external connection. The software may be executable by the processing circuitry 62. The processing circuitry 62 may be configured to control any of the methods and/or processes described herein and/or to cause such methods, and/or processes to be performed, e.g., by the VM server device 36. The memory 64 is configured to store data, programmatic software code and/or other information described herein. In some embodiments, the software may include instructions stored in memory 64 that, when executed by the processor 66 and/or PCI VM server 24, causes the processing circuitry 62 and/or configures the VM server device 36 to perform the processes described herein with respect to the VM server device 36 (e.g., processes described with reference to FIG. 6 and/or any of the other flowcharts).

In FIG. 3, the connection between the VM client device 32, server selector device 34, VM server device 36 is shown without explicit reference to any intermediary devices or connections. However, it should be understood that intermediary devices and/or connections may exist between these devices, although not explicitly shown.

Although FIG. 3 shows PCI VM client 20, PCI server selector 22 and PCI VM server 36, as being within a respective processor, it is contemplated that these elements may be implemented such that a portion of the elements is stored in a corresponding memory within the processing circuitry. In other words, the elements may be implemented in hardware or in a combination of hardware and software within the processing circuitry. In one embodiment, one or more of the PCI VM client 20, PCI server selector 22 and PCI VM server 36 may be implemented as, or may include an application, a program, a container or other set of instructions executable by the respective processor(s) associated with one or more VMs according to the techniques disclosed herein.

FIG. 4 is a flowchart of an exemplary process in a VM client device 32 for using a virtualized PCI device according to some embodiments of the present disclosure. One or more Blocks and/or functions and/or methods performed by the VM client device 32 may be performed by one or more elements of VM client device 32 such as by PCI VM client 20, processing circuitry 42, processor 46, memory 44, communication interface 40, etc. according to the example method. The example method includes transmitting (Block S100), such as by PCI VM client 20, processing circuitry 42, processor 46, memory 44, communication interface 40, a request for use of the PCI device 26. The method includes, as a result of the request, receiving (Block S102), such as by PCI VM client 20, processing circuitry 42, processor 46, memory 44, communication interface 40, an indication of an attachment of a VM server 24 to the VM client 20, the VM server 24 being associated with the PCI device 26.

In some embodiments, the PCI device 26 includes a graphics processing unit, GPU. In some embodiments, the VM server 24 is allowed a direct pass-through to the PCI device 26. In some embodiments, the VM server 24 is allowed exclusive access to the PCI device 26. In some embodiments, the VM server 24 bypasses a hypervisor associated with a virtual environment, the virtual environment including the VM client 20 and the VM server 24. In some embodiments, the VM server 24 includes device drivers 30 for the PCI device. In some embodiments, the method further includes transmitting such as by PCI VM client 20, processing circuitry 42, processor 46, memory 44, communication interface 40, a request to the VM server 24 to perform at least one computing process using the PCI device 26. In some embodiments, the method includes receiving such as by PCI VM client 20, processing circuitry 42, processor 46, memory 44, communication interface 40, information resulting from performance of the at least one computing process using the PCI device 26. In some embodiments, the method includes using an application programming interface, API, associated with the VM server 24 to run at least one computing process on the VM server 24 using the PCI device 26. In some embodiments, the method includes transmitting such as by PCI VM client 20, processing circuitry 42, processor 46, memory 44, communication interface 40, an indication of at least one requirement associated with the PCI device 26, the VM server 24 being selected based at least in part on the at least one requirement. In some embodiments, the method further includes allocating such as by PCI VM client 20, processing circuitry 42, processor 46, memory 44, communication interface 40, the at least one computing process to the VM server 24; and, as a result of receiving information resulting from performance of the at least one computing process using the PCI device 26, collecting and synchronizing, such as by PCI VM client 20, processing circuitry 42, processor 46, memory 44, communication interface 40, the received information.

FIG. 5 is a flowchart of an exemplary process in a server selector device 34 for virtualizing a PCI device according to some embodiments of the present disclosure. One or more Blocks and/or functions and/or methods performed by server selector device 34 may be performed by one or more elements of server selector device 34 such as by PCI server selector 22, processing circuitry 52, processor 56, memory 54, communication interface 50, etc. The example method includes receiving (Block S104), such as by PCI server selector 22, processing circuitry 52, processor 56, memory 54, communication interface 50, a request to use the PCI device 26. The method includes, as a result of the request, selecting (Block S106), such as by PCI server selector 22, processing circuitry 52, processor 56, memory 54, communication interface 50, a virtual machine, VM, server out of a plurality of VM servers 24. The method includes transmitting (Block S108), such as by PCI server selector 22, processing circuitry 52, processor 56, memory 54, communication interface 50, an indication of an attachment of the selected VM server 24 to a VM client 20, the VM server 24 being associated with the PCI device 26.

In some embodiments, the method further includes receiving, such as by PCI server selector 22, processing circuitry 52, processor 56, memory 54, communication interface 50, an indication of at least one requirement associated with the PCI device 26, the VM server 24 being selected based at least in part on the at least one requirement. In some embodiments, the method further includes attaching, such as by PCI server selector 22, processing circuitry 52, processor 56, memory 54, communication interface 50, the selected VM server 24 to the VM client 20. In some embodiments, the method further includes obtaining, such as by PCI server selector 22, processing circuitry 52, processor 56, memory 54, communication interface 50, application programming interface, API, information from the VM server 24. In some embodiments, the method further includes obtaining, such as by PCI server selector 22, processing circuitry 52, processor 56, memory 54, communication interface 50, a status of the VM server 24; and at least one of: updating, such as by PCI server selector 22, processing circuitry 52, processor 56, memory 54, communication interface 50, a status table with the obtained status of the VM server 24; and performing, such as by PCI server selector 22, processing circuitry 52, processor 56, memory 54, communication interface 50, an operation based on the obtained status. In some embodiments, each of the plurality of VM servers 24 is allowed exclusive access to a single PCI device 26. In some embodiments, the method further includes using, such as by PCI server selector 22, processing circuitry 52, processor 56, memory 54, communication interface 50, machine learning to at least one of select the VM server 24 out of the plurality of VM servers 24 and manage the plurality of VM servers 24.

FIG. 6 is a flowchart of an exemplary process in a VM server device 36 for virtualizing a PCI device according to some embodiments of the present disclosure. One or more Blocks and/or functions and/or methods performed by VM server device 36 may be performed by one or more elements of VM server device 36 such as by PCI VM server 24, processing circuitry 62, processor 66, memory 64, communication interface 60, etc. The example method includes receiving (Block S110), such as by PCI VM server 24, processing circuitry 62, processor 66, memory 64, communication interface 60, from a VM client 20, a request to perform at least one computing process using the PCI device 26. The method includes transmitting (Block S112), such as by PCI VM server 24, processing circuitry 62, processor 66, memory 64, communication interface 60, information resulting from performance of the at least one computing process using the PCI device 26.

In some embodiments, the method includes performing, such as by PCI VM server 24, processing circuitry 62, processor 66, memory 64, communication interface 60, the at least one computing process by running, at the VM server 24, the at least one computing process using the PCI device 26. In some embodiments, the receiving the request further includes receiving, such as by PCI VM server 24, processing circuitry 62, processor 66, memory 64, communication interface 60, the request to perform the at least one computing process via an application programming interface, API, associated with the VM server 24. In some embodiments, the method includes obtaining, such as by PCI VM server 24, processing circuitry 62, processor 66, memory 64, communication interface 60, data on which to perform the at least one computing process. In some embodiments, the method includes performing, such as by PCI VM server 24, processing circuitry 62, processor 66, memory 64, communication interface 60, the at least one computing process by running, at the VM server 24, the at least one computing process on the data using the PCI device 26. In some embodiments, the method includes providing, such as by PCI VM server 24, processing circuitry 62, processor 66, memory 64, communication interface 60, to a server selector 22, at least one of application programming interface, API, information associated with the VM server 24 and a status of the VM server 24 to the server selector 22. In some embodiments, the PCI device 26 is a graphics processing unit, GPU. In some embodiments, the method further includes performing, such as by PCI VM server 24, processing circuitry 62, processor 66, memory 64, communication interface 60, the at least one computing process via at least one of: a direct pass-through to the PCI device 26; exclusive access to the PCI device 26; bypassing a hypervisor associated with a virtual environment, the virtual environment including the VM client 20 and the VM server 24; and device drivers 30 for the PCI device 26.

Having described some embodiments for virtualizing a PCI device, such as a GPU or other accelerating PCI device, a more detailed description of some of the embodiments is described below, which may be implemented by VM client device 32 (having the PCI VM client 20), server selector device 34 (having the PCI server selector 22) and/or VM server device 36 (having the PCI VM server 24).

Some embodiments of the present disclosure may include one or more of the following:

1. Initially, all PCI devices 26 are passed through the hypervisor 28, and then a PCI VM server 24 for each PCI device 26 is created and/or assigned. Stated another way, each PCI device 26 is attached to its own PCI VM server 24.

2. Two identical intelligent PCI server selectors 22 are created. One is active, the other is standby. The server selector device 34, which includes at least one of the PCI server selectors 22, may have at least two responsibilities, the first is allocating and attaching suitable PCI VM servers 24 for the VM clients 20. The second responsibility of the server selector may be the management of the PCI VM servers 24, which can include health-checking of the PCI VM servers' 24 health and restarting dead PCI VM servers 24, etc.

3. Customers can create PCI VM clients 20 according to their requirements (e.g., size of GPU, GPU speed, etc.). These PCI VM clients 20 can be connected to the PCI VM servers 24 by the PCI server selector 22.

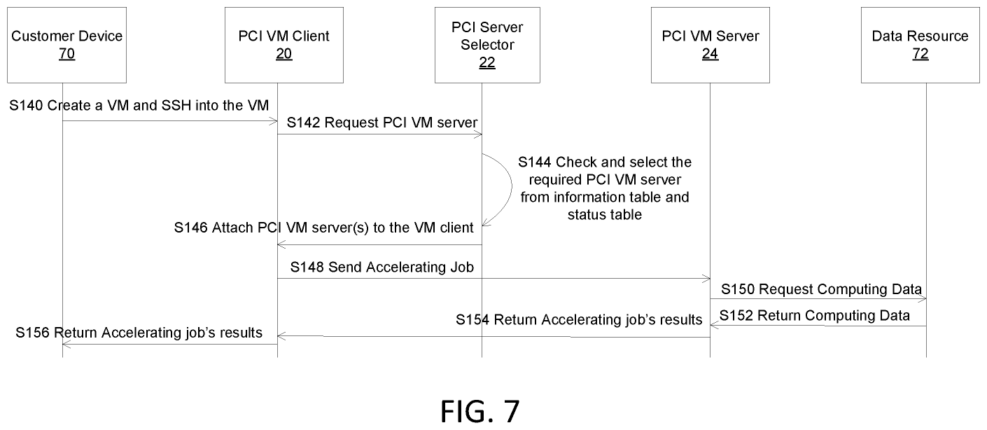

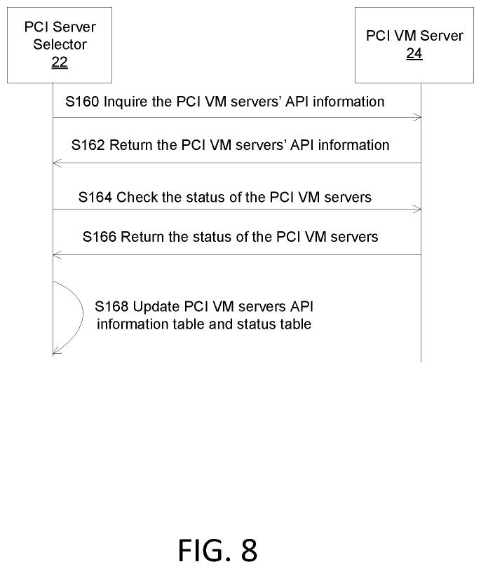

One embodiment of the present disclosure is described with reference to the call flow diagram depicted in FIGS. 7 and 8.

Some embodiments described herein may be based on OpenStack, which is a cloud operating system that controls large pools of compute, storage and network resources throughout a data center, which may be managed and/or provisioned through, e.g., APIs. It should be understood that other embodiments may be based on other OSs, or other platforms for managing and/or provisioning resources.

According to one embodiment, as depicted in FIG. 7, a customer device 70 (e.g., personal computer, tablet, other user equipment, etc.) may create a PCI VM client 20 (e.g., within OpenStack, or any other OS or platform) and may secure shell (SSH) into the PCI VM client 20, in step S140. In step S142, the PCI VM client 20 may request a PCI VM server 24 from the PCI server selector 22. In some embodiments, the request may include requirements provided by the customer device 70, such as, for example, a speed and/or size requested for the PCI device 26. In step S144, when the PCI server selector 22 receives the request, the PCI server selector 22 may check available PCI VM servers 24 from e.g., a status table of PCI VM servers (e.g., stored in memory associated with the server selector 22) and select one or more of the PCI VM servers 24 according to the requirements.

In some embodiments, the PCI server selector 22 may one or more of: maintain a history of PCI VM server 24 allocation, train and build a machine learning (ML) model using the stored history data and use the ML model to more efficiently allocate PCI VM servers 24 to PCI VM clients 20. Techniques (e.g., clustering, linear regression, neural networks, support vector machines, decision trees, etc.) for using data to train and/or build an ML model are generally known and therefore will not be discussed in greater detail herein.

The PCI server selector 22 may attach the selected one or more PCI VM servers 24 to the PCI VM client 20 in step S146. In some embodiments, API information for the selected PCI VM server(s) 24 may be provided to the PCI VM client 20 by e.g., PCI server selector 22. The API information may be used by the PCI VM client 20 to request services from the selected PCI VM server(s) 24. For example, the PCI VM client 20 may use the API of the selected PCI VM server(s) 24 to run workloads using the accelerating resource (e.g., PCI device 26). In step S148, the PCI VM client 20 may send (e.g., via the API) an accelerating job to the PCI VM server 24. The workload is not executed by the PCI VM client 20. Instead, the workload is executed on the selected and attached PCI VM server(s) 24.

The PCI VM server(s) 24 may prepare the data for computing (e.g., by the PCI device 26) and then send back the results to the PCI VM client 20. For example, in step S150, the PCI VM server 24 may request computing data from a data resource 72. The data may be data associated with the accelerating job requested from the PCI VM client. For example, the data may be stored in a storage resource in the cloud and/or whose location may be indicated in the accelerating job request in step S148. In other embodiments, the data to be processed by the PCI device 26 may be obtained by the PCI VM server 24 in other ways. In step S152, the computing data is returned from the data resource 72 to the PCI VM server 24. The PCI VM server 24 may prepare the data for computing by the PCI device 26 and may instruct the PCI device 26 to perform the computations on the data by using e.g., the device drivers 30 for the PCI device 26. The PCI VM server 24 has a direct pass-through to the PCI device 26 and can bypass the hypervisor 28; therefore, computations on the data may have improved performance (as compared to some existing techniques, such as API forwarding or full GPU virtualization). In step S154, after the PCI device 26 has performed the data computations, the PCI VM server 24 may return the accelerating job's results to the PCI VM client 20. In step S156, the PCI VM client 20 may return the accelerating job's results the customer device 70.

FIG. 8 shows an example call flow diagram for performing health-checks and selecting (e.g., step S144 in FIG. 7) a PCI VM server 24 according to some arrangements disclosed herein. In step S160, the PCI server selector 22 may inquire about the PCI VM servers' 24 API information. In step S162, the PCI VM server 24 may return the API information to the PCI server selector 22. In some embodiments, the API information may be used by a PCI VM client 20 and/or the PCI server selector 22 to communicate with the PCI VM server 24 (e.g., submitting service requests for performing accelerating jobs, checking status, restarting the PCI VM server, etc.). In step S164, the PCI server selector 22 may check the status of the PCI VM server 24. In step S166, the PCI VM server 24 may return the requested status to the PCI server selector 22. In step S168, the PCI server selector 22 may update an API information table and/or status table for the PCI VM server 24. The information in the API information table and/or status table may be used by the PCI server selector 22 to allocate, select and/or attach PCI VM servers 24 to PCI VM clients 20. The PCI server selector 22 may maintain a list of all the PCI VM servers 24 in the data center.

Some embodiments for improving the usage and efficiency of physical hardware accelerating resources (e.g., PCI virtualization) within the cloud have been described.

In some embodiments, each PCI device 26 is attached to an individual PCI VM server 24. All features of the PCI device 26 may be packaged into a single PCI VM server 24. This design has some advantages over existing techniques, such as each PCI device 26 is isolated from other devices and the PCI VM server 24 can be restarted faster than with existing GPU virtualization arrangements. These advantages may be particularly useful when some PCI VM servers 24 have problems. The PCI VM servers 24 can be flexibly organized to supply accelerating services according to customer requirements.

In some embodiments, the PCI server selector 22 is an intelligent PCI server selector 22 and is not only a router that connects the PCI VM clients 20 and the PCI VM servers 24, but also an intelligent VM server's management unit. The PCI server selector 22 may be configured to select suitable PCI accelerating VM servers 24 according to the customer's requirements and attaching them to the PCI VM clients 20. In addition, the PCI server selector 22 may be configured to check each PCI VM server's 24 health and running status, and if there is an abnormal situation, the PCI server selector 22 can operate accordingly, such as, for example, restart the PCI VM server 24 and/or attach a backup PCI VM server 24 to the PCI VM client 20 to avoid or minimize interruptions.

In some embodiments, the main computing workload is not performed on the PCI VM client 20. Instead, the PCI VM client 20 allocates workload/accelerating jobs on the attached accelerating PCI VM servers 24 and then collect the results from the PCI VM servers 24. The PCI VM servers 24 are configured to prepare the data and computing. This technique can avoid frequently transferring data between clients 20 and servers 24 and/or exploit the computing advantages of the PCI VM servers 24.

Abbreviations that may be used in the preceding description include:

| Abbreviation | Description |
|---|---|
| PCI | Peripheral Component Interconnect |
| GPU | Graphics Processing Unit |
| FPGA | Field Programmable Gate Array |
| IPSS | Intelligent PCI Server Selector |

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method for a virtual machine, VM, client for using a virtualized peripheral component interconnect, PCI, device, the method comprising:
transmitting a request for use of the PCI device; and
as a result of the request, receiving an indication of an attachment of a VM server to the VM client, the VM server being associated with the PCI device.

2. The method of claim 1, wherein the PCI device includes a graphics processing unit, GPU.

3. The method of claim 1, wherein at least one of:
the VM server is allowed a direct pass-through to the PCI device;
the VM server is allowed exclusive access to the PCI device;
the VM server bypasses a hypervisor associated with a virtual environment, the virtual environment including the VM client and the VM server; and
the VM server having device drivers for the PCI device.

4. The method of claim 1, further comprising:
transmitting a request to the VM server to perform at least one computing process using the PCI device; and
receiving information resulting from performance of the at least one computing process using the PCI device.

5. The method of claim 1, further comprising:
using an application programming interface, API, associated with the VM server to run at least one computing process on the VM server using the PCI device.

6. The method of claim 1, further comprising:
transmitting an indication of at least one requirement associated with the PCI device, the VM server being selected based at least in part on the at least one requirement.

7. The method of claim 1, further comprising:
allocating the at least one computing process to the VM server; and
as a result of receiving information resulting from performance of the at least one computing process using the PCI device, collecting and synchronizing the received information.

8. A method for a server selector for virtualizing a physical peripheral component interconnect, PCI, device, the method comprising:
receiving a request to use the PCI device;
as a result of the request, selecting a virtual machine, VM, server out of a plurality of VM server; and
transmitting an indication of an attachment of the selected VM server to a VM client, the VM server being associated with the PCI device.

9. The method of claim 8, further comprising:
receiving an indication of at least one requirement associated with the PCI device, the VM server being selected based at least in part on the at least one requirement.

10. The method of claim 8, further comprising:
attaching the selected VM server to the VM client.

11. The method of claim 8, further comprising:
obtaining application programming interface, API, information from the VM server.

12. The method of claim 8, further comprising:
obtaining a status of the VM server; and
at least one of:
updating a status table with the obtained status of the VM server; and
performing an operation based on the obtained status.

13. The method of claim 8, wherein each of the plurality of VM servers is allowed exclusive access to a single PCI device.

14. The method of claim 8, further comprising:
using machine learning to at least one of select the VM server out of the plurality of VM servers and manage the plurality of VM servers.

15.-21. (canceled)

22. A device for a virtual machine, VM, client for using a virtualized peripheral component interconnect, PCI, device, the device comprising processing circuitry and memory, the memory comprising instructions and the processing circuitry configured to execute the instructions to cause the device to:
transmit a request for use of the PCI device; and
as a result of the request, receive an indication of an attachment of a VM server to the VM client, the VM server being associated with the PCI device.

23. The device of claim 22, wherein the PCI device includes a graphics processing unit, GPU.

24. The device of claim 22, wherein at least one of:
the VM server is allowed a direct pass-through to the PCI device;
the VM server is allowed exclusive access to the PCI device;
the VM server bypasses a hypervisor associated with a virtual environment, the virtual environment including the VM client and the VM server; and
the VM server having device drivers for the PCI device.

25. The device of claim 22, wherein the processing circuitry is further configured to execute the instructions to cause the device to:
transmit a request to the VM server to perform at least one computing process using the PCI device; and
receive information resulting from performance of the at least one computing process using the PCI device.

26. The device of claim 22, wherein the processing circuitry is further configured to execute the instructions to cause the device to:
use an application programming interface, API, associated with the VM server to run at least one computing process on the VM server using the PCI device.

27. The device of claim 22, wherein the processing circuitry 424 is further configured to execute the instructions to cause the device to:
transmit an indication of at least one requirement associated with the PCI device, the VM server being selected based at least in part on the at least one requirement.

28.-44. (canceled)
